(19) United States
(12) Patent Application Publication
(10) Pub. No.: US 2007/0212929 A1
(43) Pub. Date: Sep. 13, 2007

(54) Breakaway connector assembly

(76) Inventors: Tzu-Hsuan Huang, Tucheng City (TW); Lan Zhai, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/370,980

(22) Filed: Mar. 9, 2006

(51) Int. Cl. H01R 12/24

(52) U.S. Cl. 439/498

(57) ABSTRACT

A breakaway connector assembly for connecting a first electrical apparatus to a second electrical apparatus includes an adapter receptacle and an adapter plug. The adapter receptacle has at least one first electrical terminal therein and a first mating portion. The adapter plug has at least one second electrical terminal therein and a second mating portion configured to mate with the first mating portion. The second electrical terminal electrically connects the first electrical terminal when the first and second mating portions are mated. One of the adapter receptacle and the adapter plug has a magnetic element disposed on the mating portion thereof, the other has an attractable means disposed on the mating portion thereof for being attracted by the magnetic element to maintain the connection between the adapter receptacle and the adapter plug. Therefore a breakaway connection is formed between the adapter receptacle and the adapter plug.

### BACKGROUND OF THE INVENTION

1. Field of the Invention

The present invention relates to a connector assembly, and more particularly to a breakaway connector assembly.

2. The Related Art

At present, computers, mobile phones etc. all need to connect power source or other peripherals, so various cable assemblies must be used. The cable assembly has a first connector at one end for connecting such electrical apparatus and a second connector at the other end for connecting the power source or the peripheral so as to realize the power/signal transmission between the electrical apparatus and the power source or the peripheral.

When the electrical apparatus is connected with the power source or the peripheral, the user is often stumbled by the cable because of carelessness. Owing to having a specific connecting force between the first connector and the electrical apparatus, the first connector and the electrical apparatus is difficulty to break away from each other. So, if the electrical apparatus is heavy enough, the user may be tripped. Otherwise, if the electrical apparatus is light, the electrical apparatus may fall.

U.S. Pat. No. 6,461,192, which provides a breakaway connecting system, comprises a first and second lengthwise portions that are coupled by an axially engageable safety breakaway connector. Thus, if the user trips over the cable, the cable will become decoupled at the breakaway connector, thus the electrical apparatus is protected from being jerked to the ground.

In this conventional art, the breakaway connector has a female part and a male part. The first lengthwise portion includes the female part having a receiving bore formed therein. The second lengthwise portion includes the male part having a protruding portion that is received in the receiving bore to establish an electrical connection between first and second lengthwise portions.

Though the female part and the male part of the breakaway connector preferably disengage or break away from each other under an axially applied tension so as to release the tension in cable, which prevents the electrical apparatus from being pulled out of place or off of work surface, the breakaway structure of the connecting system is complicated and the protruding portion of the breakaway connector is easily deformed so as to shorten the life of the breakaway connecting system.

### SUMMARY OF THE INVENTION

An object of the present invention is to provide a breakaway connector assembly comprising an adapter receptacle and an adapter plug. The adapter receptacle has at least one first electrical terminal therein and a first mating portion. The adapter plug has at least one second electrical terminal therein and a second mating portion configured to mate with the first mating portion. The second electrical terminal electrically connects the first electrical terminal when the first and second mating portions are mated. One of the adapter receptacle and the adapter plug has a magnetic element disposed on the mating portion thereof, and the other has an attractable means disposed on the mating portion thereof for being attracted by the magnetic element to maintain the connection between the adapter receptacle and the adapter plug. Therefore a breakaway connection is formed between the adapter receptacle and the adapter plug.

In a preferred embodiment of the invention, the breakaway connector assembly is used in a breakaway connecting system. The breakaway connecting system adapted to connect a first electrical apparatus to a second electrical apparatus comprises a first cable connector assembly and a second cable connector assembly. The first cable connector assembly comprises a first cable, a first connector connecting to a first end of the first cable for connecting the first electrical apparatus, and the adapter receptacle of the breakaway connector assembly connecting to a second end of the first cable opposite to the first end. The second cable connector assembly comprises a second cable, a second connector connecting to a first end of the second cable for connecting to the second electrical apparatus, and the adapter plug of the breakaway connector assembly connecting to a second end of the second cable opposite to the first end. When the adapter receptacle and the adapter plug mate with each other, a breakaway connection is formed for the system between the first cable and the second cable.

In a further preferred embodiment, the breakaway connector assembly is used in a breakaway connecting system too. The breakaway connecting system for connecting a first electrical apparatus to a second electrical apparatus comprises the adapter receptacle of the breakaway connector assembly and a cable connector assembly. The cable connector assembly comprises a cable, a connector connecting to a first end of the cable for connecting to the second apparatus, and the adapter plug of the breakaway connector assembly connecting to a second end of the cable opposite to the first end. The adapter receptacle further has a connecting portion opposite to the first mating portion for connecting the first electrical apparatus. When the adapter receptacle and the adapter plug mate with each other, a breakaway connection is formed for the system there-between.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded perspective view of a first embodiment of a breakaway connector assembly according to the present invention;

FIG. 2 is a perspective view of an adapter receptacle for the breakaway connector assembly shown in FIG. 1;

FIG. 3 is a perspective view of an adapter plug for the breakaway connector assembly shown in FIG. 1;

FIG. 4 is a perspective view showing the breakaway connector assembly of the first embodiment being used in a breakaway connecting system for connecting two electrical apparatus;

FIG. 5 is an exploded perspective view of a second embodiment of a breakaway connector assembly according to the present invention;

FIG. 6 is a perspective view showing the breakaway connector assembly of the second embodiment being used in a breakaway connecting system for connecting two electrical apparatus.

### DETAILED DESCRIPTION OF THE PREFERRED EMBODIMENT

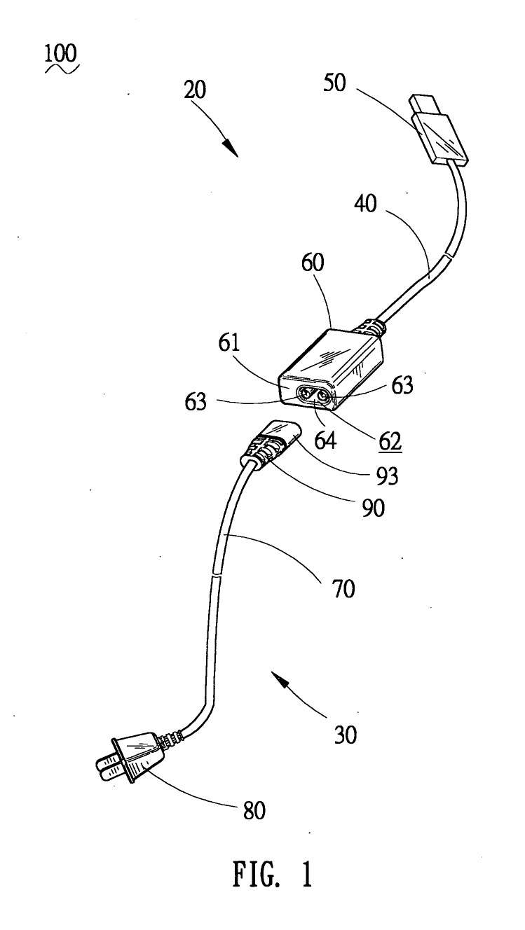

Referring to FIGS. 1-3, a breakaway connector assembly and a breakaway connecting system 100 using the breakaway connector assembly according to a first embodiment of the present invention is provided. The breakaway connector assembly comprises an adapter receptacle 60 and an adapter plug 90. The breakaway connecting system 100 comprises a first cable connector assembly 20 that has the adapter receptacle 60 and a second cable connector assembly 30 that has the adapter plug 90. The first cable connector assembly 20 comprises a first cable 40, a first connector 50 connecting to a first end of the first cable 40, and the adapter receptacle 60 connecting to a second end of the first cable 40 opposite to the first end. The second cable connector assembly 30 comprises a second cable 70, a second connector 80 connecting to a first end of the second cable 70, and the adapter plug 90 connecting to a second end of the second cable 70 opposite to the first end.

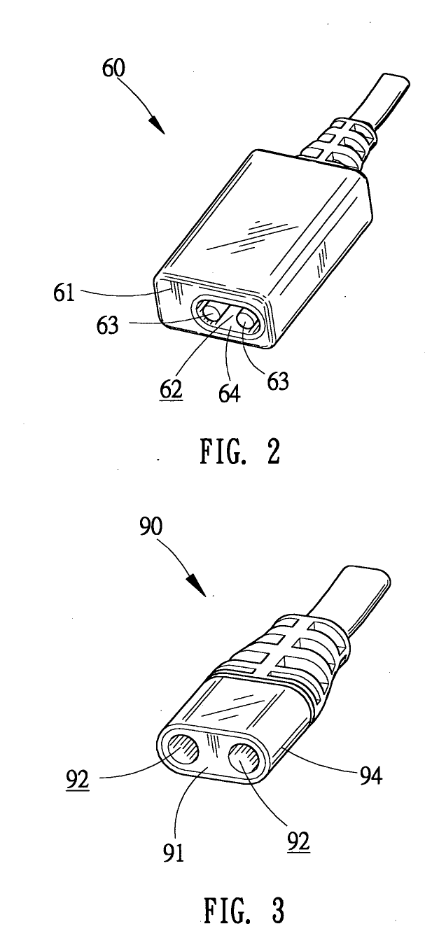

With reference to FIG. 2, the adapter receptacle 60 has a first mating portion 61. A mating cavity 62 is defined in the first mating portion 61. A pair of first electrical terminals 63 extends from inner of the adapter receptacle 60 into the mating cavity 62. A magnetic element 64, e.g., a permanent magnet, is disposed on inner surface of the mating cavity 32.

As shown in FIG. 3, the adapter plug 90 has a second mating portion 91 configured to mate with the first mating portion 61 of the adapter receptacle 60. Concretely, the second mating portion 91 is inserted into the mating cavity 62 when the adapter plug 90 and the adapter receptacle 60 are mated. A pair of cavities 92 is defined in the second mating portion 91 in order to receive the first electrical terminals 63 therein. A pair of second electrical terminals (not shown) extends from inner of the adapter plug 60 into the pair of cavities 92 for electrically connecting the first electrical terminals 63. An attractable means 94 is disposed on outer surface of the second mating portion 91. Preferably, the attractable means 94 is also a permanent magnet. It will be appreciated that, alternatively, the attractable means 94 can use other things, such as a metal member, or metal powder integrally molded with the second mating portion 91, so long as it can be attracted by the magnetic element 64. It will be further appreciated that, alternatively, the magnetic element 64 and the attractable means 94 can be swapped. In any case of the above modifications, the magnetic element 64 attracts the attractable means 94 when the adapter receptacle 60 and the adapter plug 90 are mated. The magnetic attraction force between the magnetic element 64 and the attractable means 94 maintains the connection between the adapter receptacle 60 and the adapter plug 90.

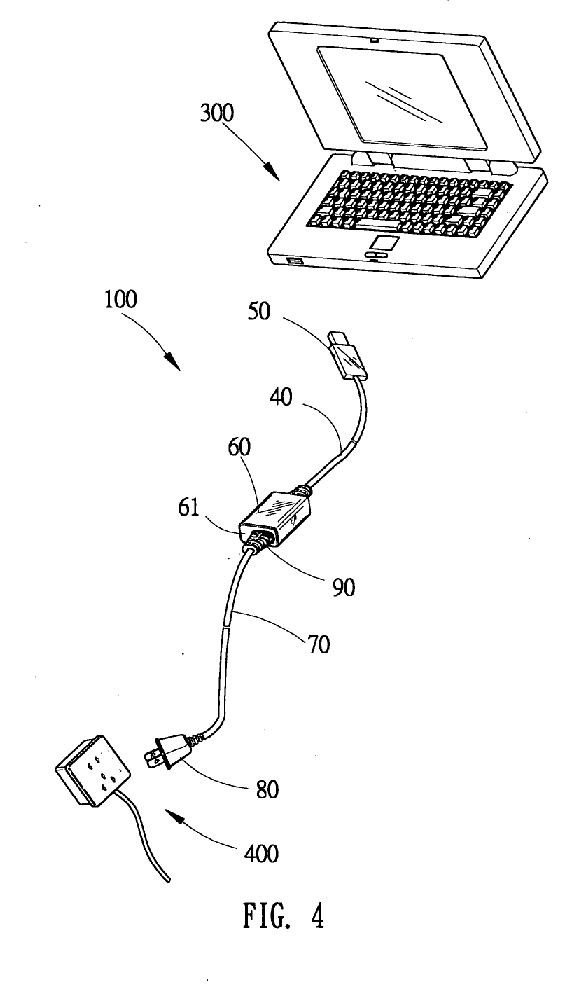

Referring to FIG. 4, in assembly, the second mating portion 91 of the adapter plug 90 is inserted into the mating cavity 62 of the adapter receptacle 60 in which the first electrical terminals 63 electrically connect the second electrical terminals, and the magnetic element 64 attracts the attractable means 94 to maintain the connection. As magnetic connection between the magnetic element 64 and the attractable means 94 can be broke easily upon impact, a breakaway connection is formed between the adapter receptacle 60 and the adapter plug 90.

Referring to FIG. 4 again, the breakaway connecter assembly forms a breakaway connection for the breakaway connecting system 100 between the first cable 40 and the second cable 70. In use, the first connector 50 connects a portable computer 300 that acts as a first electrical apparatus; the second connector 80 connects an outer power socket 400 that acts as a second electrical apparatus. Thus, the power transmission between the portable computer 300 and the power socket 400 is realized.

In above-mentioned course of using, once the user is stumbled by the breakaway connecting system 100 because of carelessness, the adapter receptacle 60 and the adapter plug 90 break away from each other firstly, thus the user is protected from being tripped, and the portable computer 300 is protected from falling.

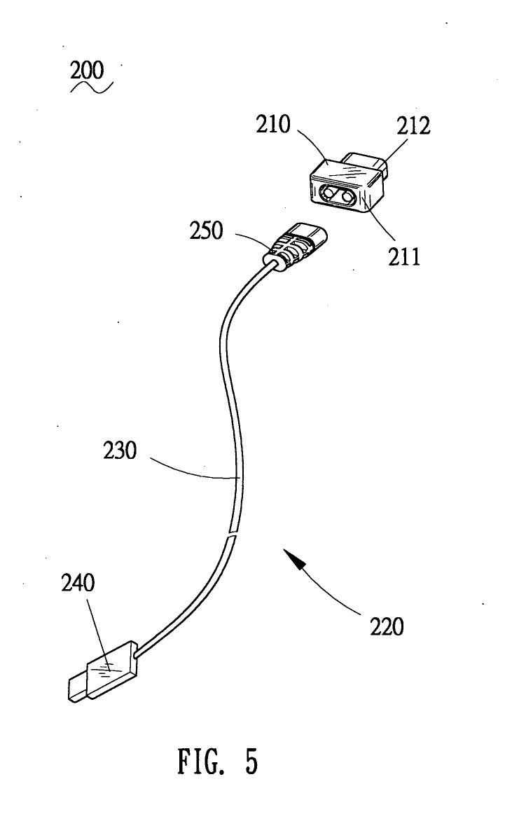

With reference to FIG. 5, a second embodiment of the present invention shows the breakaway connector assembly being used in a breakaway connecting system 200. The breakaway connecting system 200 for connecting a first electrical apparatus to a second electrical apparatus comprises an adapter receptacle 210 and a cable connector assembly 220. The cable connector assembly 220 comprises a cable 230, a connector 240 connecting to a first end of the cable 230, and an adapter plug 250 connecting to a second end of the cable 230 opposite to the first end.

Referring to FIG. 5 again, in this embodiment, the structure of the adapter plug 250 is the same as the adapter plug 40 in the first embodiment. The adapter receptacle 210 has a first mating portion 211, the difference between the adapter receptacle 210 and the adapter receptacle 90 in the first embodiment is that the adapter receptacle 210 has a connecting portion 212 opposite to the first mating portion 211 for connecting the first electrical apparatus.

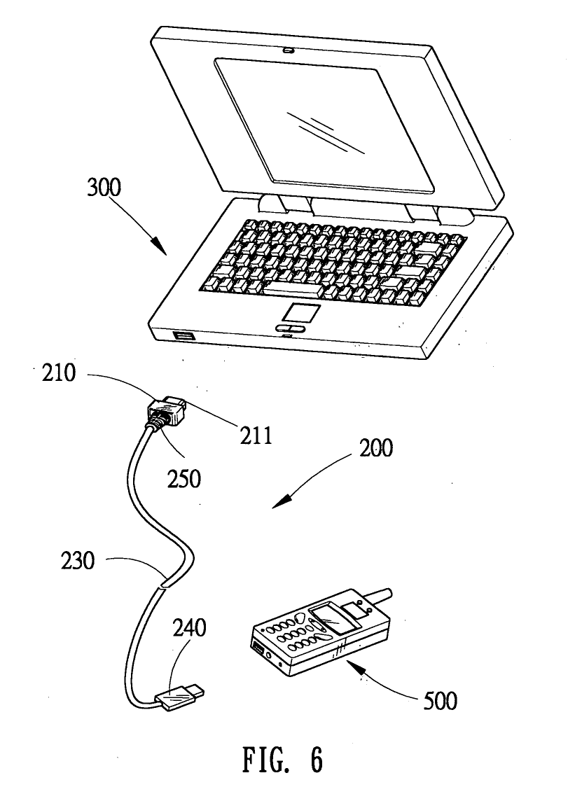

Referring to FIG. 6, in use, the adapter receptacle 210 and the adapter plug 250 form an electrical and magnetic breakaway connection for the system there-between. The connecting portion 212 of the adapter receptacle 210 is adapted to connect a portable computer 300 that acts as a first electrical apparatus; the connector 240 is adapted to connect a mobile phone 500 that acts as a second electrical apparatus. Thus, the signal transmission between the portable computer 300 and the mobile phone 500 is realized.

In above-mentioned course of using, once the user is stumbled by the breakaway connecting system 200 because of carelessness, the adapter receptacle 210 and the adapter plug 250 break away from each other firstly, thus the user is protected from being tripped, and the portable computer 300 and the mobile phone 500 is protected from falling.

As illustrating above, the breakaway connecting system 100, 200 provides a breakaway connecting structure by the magnetic attraction between the adapter receptacle 60, 210 and the adapter plug 90, 250. Comparing to the conventional mechanical breakaway connecting structure, the breakaway connecting structure by the magnetic attraction has a simpler structure and a longer performance life.

While the present invention has been described with reference to specific embodiments thereof, the description is illustrative and is not to be construed as limiting the invention. Various modifications to the present invention may be made to the preferred embodiments in light of the teaching. Such modifications and variations that may be apparent to a person skilled in the art are intended to be included within the scope of this invention as defined by the accompanying claims.

What is claimed is:

1. A breakaway connector assembly comprising:
an adapter receptacle having at least one first electrical terminal therein and a first mating portion;
an adapter plug having at least one second electrical terminal therein and a second mating portion configured to mate with the first mating portion, the second electrical terminal electrically connecting the first electrical terminal when the first and second mating portions are mated;
wherein one of the adapter receptacle and the adapter plug has a magnetic element disposed on the mating portion thereof, the other has an attractable means disposed on the mating portion thereof for being attracted by the magnetic element to maintain the connection between the adapter receptacle and the adapter plug;
whereby a breakaway connection is formed between the adapter receptacle and the adapter plug.

2. The breakaway connector assembly as claimed in claim 1, wherein the magnetic means is a permanent magnet.

3. The breakaway connector assembly as claimed in claim 1, wherein the attractable means is a permanent magnet.

4. The breakaway connector assembly as claimed in claim 1, wherein the attractable means is a metal member.

5. The breakaway connector assembly as claimed in claim 1, wherein the attractable means is metal powder integrally molded with the corresponding mating portion.

6. A breakaway connecting system for connecting a first electrical apparatus to a second electrical apparatus comprising:
a first cable connector assembly comprising a first cable, a first connector connecting to a first end of the first cable, and an adapter receptacle connecting to a second end of the first cable opposite to the first end, the first connector being adapted to connect the first electrical apparatus, the adapter receptacle having at least one first electrical terminal therein and a first mating portion; and
a second cable connector assembly comprising a second cable, a second connector connecting to a first end of the second cable, and an adapter plug connecting to a second end of the second cable opposite to the first end, the second connector being adapted to connect the second electrical apparatus, the adapter plug having at least one second electrical terminal therein and a second mating portion configured to mate with the first mating portion of the adapter receptacle, the second electrical terminal electrically connecting the first electrical terminal when the first and second mating portions are mated;
wherein one of the adapter receptacle and the adapter plug has a magnetic element disposed on the mating portion thereof, the other has an attractable means disposed on the mating portion thereof for being attracted by the magnetic element to maintain the connection between the adapter receptacle and the adapter plug;
whereby the adapter receptacle and the adapter plug form a breakaway connection for the system between the first cable and the second cable.

7. The breakaway connecting system as claimed in claim 6, wherein the magnetic means is a permanent magnet.

8. The breakaway connecting system as claimed in claim 6, wherein the attractable means is a permanent magnet.

9. The breakaway connecting system as claimed in claim 6, wherein the attractable means is a metal member.

10. The breakaway connecting system as claimed in claim 6, wherein the attractable means is metal powder integrally molded with the corresponding mating portion.

11. A breakaway connecting system for connecting a first electrical apparatus to a second electrical apparatus comprising:
an adapter receptacle having at least one first electrical terminal therein, a first mating portion, and a connecting portion opposite to the first mating portion adapted to connect the first electrical apparatus; and
a cable connector assembly comprising a cable, a connector connecting to a first end of the cable, and an adapter plug connecting to a second end of the cable opposite to the first end, the connector being adapted to connect the second electrical apparatus, the adapter plug having at least one second electrical terminal therein and a second mating portion configured to mate with the first mating portion of the adapter receptacle, the second electrical terminal electrically connecting the first electrical terminal when the first and second mating portions are mated;
wherein one of the adapter receptacle and the adapter plug has a magnetic element disposed on the mating portion thereof, the other has an attractable means disposed on the mating portion thereof for being attracted by the magnetic element to maintain the connection between the adapter receptacle and the adapter plug;
whereby the adapter receptacle and the adapter plug form a breakaway connection for the system there-between.

12. The breakaway connecting system as claimed in claim 11, wherein the magnetic means is a permanent magnet.

13. The breakaway connecting system as claimed in claim 11, wherein the attractable means is a permanent magnet.

14. The breakaway connecting system as claimed in claim 11, wherein the attractable means is a metal member.

15. The breakaway connecting system as claimed in claim 11, wherein the attractable means is metal powder integrally molded with the corresponding mating portion.
